(19) United States
(12) Patent Application Publication
(10) Pub. No.: US 2025/0042495 A1
(43) Pub. Date: Feb. 6, 2025

(54) SELF-POWERED SYSTEM FOR A BICYCLE

(71) Applicant: CLASSIFIED CYCLING B.V., Antwerpen (BE)

(72) Inventors: Roëll Marie VAN DRUTEN, Eindhoven (NL); Thomas Jean VALERO, Eindhoven (NL)

(21) Appl. No.: 18/718,622

(22) PCT Filed: Dec. 23, 2022
(86) PCT No.: PCT/EP2022/087824

§ 371 Date: Jun. 11, 2024

(30) Foreign Application Priority Data
Dec. 24, 2021 (NL) 2030292

(51) Int. Cl. B62J 43/30; B62J 45/40; B62M 25/08

(52) U.S. Cl. CPC B62J 43/30; B62J 45/40; B62M 25/08

(57) ABSTRACT

The disclosure relates to a system for a bicycle (1000), wherein the system comprises one or more electronic sensors, and/or one or more electronic actuators (600), and an energy harvesting unit configured for harvesting energy and supplying the harvested energy to the one or more electronic actuators (600) and/or the one or more electronic actuators (600).

### FIELD

The invention relates to self-powered systems for bicycles.

### BACKGROUND

Modern bicycles are provided with various electronic actuators such as for shifting gears. Performance oriented bicycles for example, such as for road racing or mountain biking, typically include two electronic gearshift actuators, e.g. a front derailleur and a rear derailleur. Each of these gearshift actuators is controlled by a respective electronic shifter sensor mounted to a handlebar of the bicycle, e.g. a left hand shifter for controlling the front derailleur and a right hand shifter for controlling the rear derailleur. Additional electronic sensors and actuators can be provided for various other functionalities, such as electronic brake actuators and electronic power sensors.

Each of these electronic sensors and actuators require an electric power supply, which is typically provided by local batteries which need regular replacement and/or recharging from the grid.

### SUMMARY

It is an aim to provide a user-friendly system for powering the various electronic sensors and actuators of a bicycle.

According to an aspect, a system for a bicycle is provided, wherein the system comprises one or more electronic sensors, and/or one or more electronic actuators, and an energy harvesting unit configured for harvesting energy and supplying the harvested energy to the one or more electronic actuators and/or the one or more electronic actuators. Hence, self-powered system for a bicycle is obtained which obviates the regular recharging or replacement of empty batteries.

Optionally, the energy harvesting unit is arranged for converting kinetic energy of a bicycle component and/or radiation, e.g. thermal and/or solar, energy into electric energy, and supplying the electric energy to the one or more electronic sensors and/or the one or more electronic actuators.

Optionally, the one or more electronic sensors include one or more of an electronic shifter sensor, an electronic brake sensor, an electronic power sensor, an electronic cadence sensor, an electronic speed sensor, and an electronic position sensor.

Optionally, the one or more electronic actuators include one or more of an electronic shift actuator, an electronic brake actuator, electronic damper adjustment, and an electronic seat-post height actuator.

Optionally, the system includes an energy storage device, e.g. a rechargeable battery, for storing the harvested energy. Hence an energy buffer can be created.

Optionally, the energy harvesting unit comprises a plurality of energy converter modules for converting kinetic energy of a bicycle component and/or radiation energy into electric energy. Energy can be harvested from various components of the bicycle and/or from its environment. Hence multiple energy harvesting modules may be provided. The energy harvesting unit may alternatively comprise only one energy harvesting module.

Optionally, each energy converter module is connected to a different one of the one or more electronic sensors and/or one or more electronic actuators. Hence, each energy converter module may be dedicated for powering a particular one electronic sensor or actuator. For example, a first energy converter module may be connected to a first electronic actuator for powering the first electronic actuator, and a second energy converter module may be connected to a second, different, electronic actuator for powering the second electronic actuator. It is possible that at least two energy converter modules are provided, each connected to one or more different ones of the one or more electronic sensors and/or one or more electronic actuators. For instance, a first energy converter module can be connected to one or more electronic shifter sensors, e.g. at the handlebars, while a second energy converter module can be connected to one or more electronic shifter actuators. The electronic shifter sensor can be in wireless communication with an associated electronic shifter actuator.

Optionally, the electronic shifter sensor is part of a manually operable shifter, wherein the electronic shifter sensor is configured for sensing a manual user actuation thereof and transmitting an electronic shift signal upon sensing the user actuation to command a transmission ratio change of the transmission. The manually operable shifter can include a body, e.g. mountable to the handlebars, and one or more levers and/or buttons to be manually actuated on the body. The electronic shifter sensor can be configured to sense a manual user actuation of the one or more levers and/or buttons. The manually operable shifter can include a base fixable to a handlebar of the bicycle, an operating element coupled to the base so as to be rotatable with respect to the base about a rotation axis parallel to a local center line of the handlebar when the base is fixed to the handlebar wherein the electronic shifter sensor is configured for sensing a manual user actuation of the operating element. The operating element can be substantially ring-shaped, such as substantially cylindrical, optionally tapered and/or beveled, optionally including one or more protrusions and/or depressions. The substantially ring-shaped operating element can be mounted to be rotatable about the handlebar.

Optionally, each energy converter module is connected to power only said different one electronic sensor or electronic actuator. For example, the first energy converter module may be connected only to the first electronic actuator, and a second energy converter module may be connected only to a second electronic actuator. It is possible that at least two energy converter modules are provided, each connected to power only said different ones of the electronic sensors and/or electronic actuators.

Optionally, each energy converter module is local to the electronic sensor or actuator it is connected to. Hence, the energy converter module is in close proximity of the electronic sensor or actuator it is connected to, e.g. within less than 10 cm, such as included in a common housing with the electronic sensor or actuator it is connected to. Optionally, each energy converter module includes a module battery. Hence, energy converted by an energy converter module may be stored in its own battery. The system may comprise one or more batteries, each battery being connected to a different one of the one or more energy converters, and so connected to be charged only by said different one energy converter. Each battery may be connected to a different one of the one or more electronic sensors and/or electronic actuators and so connected to power only said respective one electronic sensor or electronic actuator.

Optionally, at least two energy converter modules of the plurality of converter modules share a common battery. Hence, at least two energy converter modules may charge the common battery. It will be appreciated that each of the at least two energy converter modules may additionally include a module battery. The module batteries may for instance have a relatively small capacity compared to the common battery capacity. An overflow of the module battery may for example be directed to the common battery or vice versa. The at least two energy converter modules may charge the common battery simultaneously. Alternatively, the at least two energy converter modules may charge the common battery non-simultaneously, wherein e.g. a switch is provided for switching between the at least two energy converter modules. For example with appropriate control-logic, the switch can be controlled to switch to the energy converter module generating the highest power relative to the other energy converter modules.

Optionally, the at least two energy converter modules are so connected to charge only the common battery. Hence, the each of the at least two energy converter modules may not include a module battery, but 5 exclusively charge the common battery.

Optionally, all converter modules of the plurality of energy converter modules share the common battery. The bicycle may for example comprise a single battery, wherein each of the plurality of energy converter modules is connected to the single battery.

Optionally, at least one energy converter module of the plurality of energy converter modules comprises an electric generator for converting rotary energy of a bicycle component to electric energy, the electric generator having a rotor for being mounted to a rotary component of the bicycle and a stator for being mounted to a non-rotary component of the bicycle. The rotor may include a magnetic element, e.g. a permanent magnet, and the stator may for instance include a magnetic sensor, e.g. an inductor.

Optionally, the electric generator is arranged for converting kinetic energy of a wheel of the bicycle to electric energy.

Optionally, the rotor is configured to be mounted to a brake disc of the bicycle.

Optionally, bicycle comprises a hub assembly, such as an internally geared hub assembly. The hub assembly may be include a hub transmission arranged for selectively providing one of a plurality of different transmission ratios. The hub assembly may include at least one energy converter module of the plurality of energy converter modules. The at least one energy converter module of the hub assembly may be configured to convert rotary movement of a part of the hub assembly, such as a hub of the hub assembly, to electric energy. The hub assembly may include a planetary gear set and one or more clutches, e.g. for providing two or three different transmission ratios. The hub assembly may include two planetary gear sets and one or more clutches, e.g. for providing two, three, four, six or nine different transmission ratios.

Optionally, the stator is configured to be mounted to, or integrated with, a torque support element. The torque support element is configured for supporting a torque of a hollow shaft onto the frame of the bicycle. The hollow shaft may for example be part of the hub assembly for the bicycle. The hub assembly may for example comprise the hub transmission, e.g. including a planetary gear set, wherein torque is to be transmitted from the hollow shaft to the frame, so as to keep the hollow shaft rotationally stationary with respect to the frame.

A thru-axle can for instance be provided through the hollow shaft for coupling the hub assembly to the frame. The torque support element may for example comprises a splined cam hole for receiving a complementary splined end of the shaft, so as to prevent a relative rotation between the hollow shaft and the torque support element. The torque support element may further comprise a base which extends in a direction transverse to the direction in which the hollow shaft extends, wherein the base engages the bicycle frame to prevent a rotation of the torque support element, and thus the hollow shaft, relative to the frame. The torque support may be detachably received in a dropout recess of the bicycle frame. Hence, the torque support element couples the hollow shaft to the frame. The dropout recess is typically near the brake disc.

The torque support element may for instance comprises a cam hole for receiving therein a distal end of the shaft, wherein the cam hole and the shaft are interlockingly shaped for rotationally locking the torque support device and shaft with respect to each other; a through hole extending, coaxially with respect to the cam hole, through the torque support element for allowing a thru-axle to extend therethrough; a boss configured for resting in a dropout recess; and a base extending from a remainder of the torque support element in a direction transverse to the direction in which the through hole extends, the base being arranged for engaging the frame of the bicycle outside the dropout recess so as to support torque thereon. The base may form a lever arm by which torque is supported from the hollow shaft onto the frame.

Optionally, the stator is configured to be mounted to, or integrated with, a thru-axle for mounting a wheel to the bicycle frame.

Optionally, at least one energy converter module of the plurality of energy converter modules comprises one or more photovoltaic cells for converting solar energy to electric energy. Bicycles are most often used outdoors during the day, and hence, solar energy may be a convenient energy source to be harvested by the energy harvesting unit, also when the bicycle is stationary.

Optionally, the system comprises an electronic shift sensor configured for transmitting an electronic shift signal upon sensing a user actuation thereof; and an electronic shift actuator configured for receiving the electronic shift signal and actuating a gearshift upon receipt of the electronic signal.

Optionally, the system comprises an electronic brake sensor configured for transmitting an electronic brake signal upon sensing a user actuation thereof; and an electronic brake actuator configured for receiving the electronic brake signal and actuating a brake action upon receipt of the electronic signal.

According to an aspect, a self-powered gear shifting system for a bicycle is provided. The gear shifting system comprises a transmission operable according to a plurality of transmission ratios; a manually operable shifter having an electronic shifter sensor configured for sensing a manual user actuation thereof and transmitting an electronic shift signal upon sensing the user actuation to command a transmission ratio change of the transmission; an electromechanical shift actuator configured for receiving the electronic shift signal and actuating the transmission ratio change upon receipt of the received shift signal; and an energy harvesting unit arranged for harvesting energy and supplying the harvested energy to the shifter sensor and/or the shift actuator. The energy harvesting unit can include a first energy harvesting unit for supplying energy to the shifter sensor and a second energy harvesting unit for supplying energy to the shift actuator.

According to another aspect, a self-powered brake system for a bicycle is provided. The brake system comprises a manually operable brake lever having an electronic brake sensor configured for sensing a user actuation thereof and transmitting an electronic brake signal to command a braking action, an electronic brake actuator configured for receiving the electronic brake signal and actuating a brake action for the bicycle upon receipt of the electronic brake signal, and an energy harvesting unit arranged for harvesting energy and supplying the harvested energy to the electronic brake sensor and/or the electronic brake actuator. The energy harvesting unit can include a first energy harvesting unit for supplying energy to the electronic brake sensor and a second energy harvesting unit for supplying energy to the electronic brake actuator.

According to another aspect, a bicycle is provided, comprising a self-powered system as described herein.

Optionally, the bicycle comprises a transmission operable according to a plurality of transmission ratios, the transmission having an input connected to a crank and an output connected to a driven wheel, wherein the energy harvesting unit is arranged for converting kinetic energy of a component of the transmission to electric energy.

Optionally, the transmission comprises a planetary gearset including a ring gear, a planet carrier carrying one or more planet gears, and a sun gear, wherein the energy harvesting unit is arranged for converting kinetic energy of at least one of the ring gear, the planet carrier, the one or more planet gears, and the sun gear to electric energy.

Optionally, the transmission comprises a crank spindle which is rotatably drivable relative to a bottom bracket by a front chainwheel connected to the crank, wherein energy harvesting unit is arranged for converting kinetic energy of at least one of the front chainwheel, the crank, and the crank spindle to electric energy.

Optionally, the bicycle comprises a front chainwheel connected to the crank, a rear sprocket connected to the driven wheel, an endless drive member engaging the front chainring and the rear sprocket for transferring torque between the front chainwheel and the rear sprocket, and a tensioner wheel for tensioning the endless drive member, wherein the energy harvesting unit is configured for converting kinetic energy of the tensioner wheel to electric energy.

Optionally, the energy harvesting unit comprises a photovoltaic cell for converting solar energy into electric energy.

Optionally, the bicycle comprises a front chainwheel connected to a crank, wherein the photovoltaic cell is provided on a face of the front chainwheel, particularly on an, in use, outward facing face of the front chainwheel.

Optionally, the photovoltaic cell is provided on an outer face of the hub assembly. The photovoltaic cell can e.g. be provided on an outer circumferential face of the hub assembly, e.g. between spokes flanges.

Optionally, the photovoltaic cell is provided on an outer face of the manually operable shifter. The photovoltaic cell can be provided on the body and/or the one or more levers and/or buttons. The photovoltaic cell can be provided on the base and/or the operating element, e.g. the substantially ring-shaped operating element.

Optionally, the bicycle comprises a docking member for releasably docking a bicycle computer, the docking member being arranged for being mounted to a handlebar and comprising a top surface, wherein a photovoltaic cell is provided on the docking member top surface. It will be appreciated that the bicycle computer may a dedicated bicycle computer device, or an all-purpose computer device such as a smartphone or tablet.

Optionally, the top surface comprises a central part for receiving thereon the bicycle computer in a docking position, and a peripheral part configured to remain uncovered when the bicycle computer is received in the docking position, wherein a photovoltaic cell is provided at least at the peripheral portion, and optionally also at the central part.

According to an aspect, a docking member for a bicycle is provided for releasably docking a bicycle computer, the docking member being arranged for being mounted to a handlebar of the bicycle, wherein the docking member comprises a photovoltaic cell provided on a, in use when mounted to the bicycle handlebar, top face of the docking member. Optionally, the top face of the docking member comprises a central part for receiving thereon the bicycle computer in a docking position, and a peripheral part configured to remain uncovered when the bicycle computer is received in the docking position, wherein a photovoltaic cell is provided at least at the peripheral portion, and optionally also at the central part. It will be appreciated that the bicycle computer may a dedicated bicycle computer device, or an all-purpose computer device such as a smartphone or tablet. The photovoltaic cell on the docking member may charge a battery when the bicycle computer is not docked thereon.

Optionally, the bicycle comprises a frame, wherein the photovoltaic cell is provided on a portion of the frame, particularly on a, in use, top face of the frame.

Optionally, the bicycle comprises a fender, wherein the photovoltaic cell is provided on the fender, particularly on a, in use, top face of the fender.

Optionally, the bicycle comprises a handlebar, wherein a photovoltaic cell is provided on the handlebar, particularly on a, in use, top face of the handle bar.

It will be appreciated that any of the aspects, features and options described herein can be combined. It will particularly be appreciated that any of the aspects, features and options described in view of the system apply equally to the bicycle, and vice versa.

### BRIEF DESCRIPTION OF THE DRAWINGS

Embodiments of the present invention will now be described in detail with reference to the accompanying drawings in which:

FIG. 1 shows a bicycle;

FIGS. 2-5 show a rear of a bicycle;

FIG. 6 shows a energy converter module;

FIGS. 7A-7B show an a handlebar provided with energy converter module;

FIGS. 8A-8B show an energy converter module.

### DETAILED DESCRIPTION

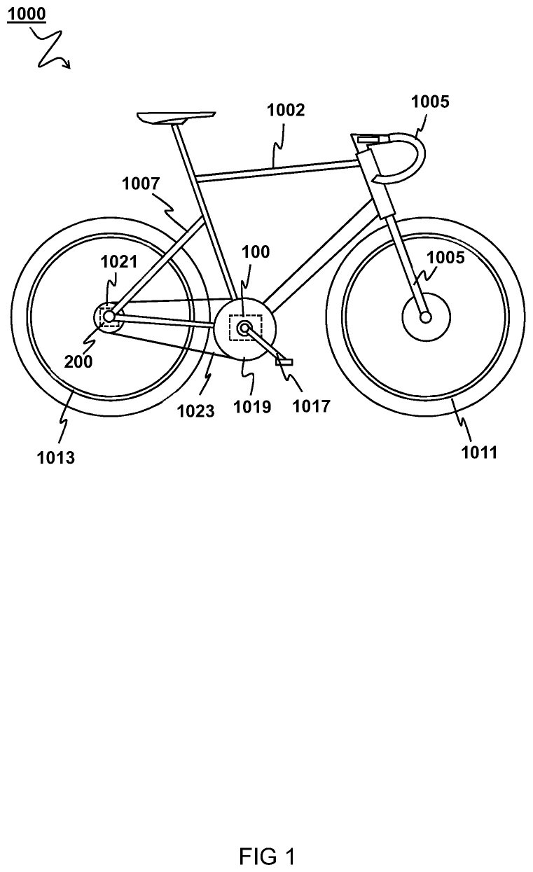

FIG. 1 shows a bicycle 1000. The bicycle 1000 comprises a frame 1002 with a front fork 1005 and a rear fork 1007, as well as a front wheel and a rear wheel 1011, 1013 located in the front and rear fork respectively. The bicycle 1000 further comprises a crank 1017, and a front chain wheel 1019. The bicycle 1000 also comprises a rear sprocket 1021 coupled to a rear wheel hub of the rear wheel 1013, wherein a chain 1023 threads over the front chain wheel 1019 and rear sprocket 1021. In this example, the bicycle 1000 comprises a first transmission 100, which is interconnected between the crank 1017 and front chain wheel 1019, and a second transmission 200 which is interconnected between the rear sprocket 1021 and the rear wheel hub 1022. Here, the second transmission is housed in a rear wheel hub assembly 2024. The first transmission 100 is operable according to multiple transmission ratios and includes a first gearshift actuator for actuating a gear shift with the first transmission 100. The second transmission 200 is also operable according to multiple transmission ratios and includes a second gearshift actuator for actuating a gear shift with the second transmission 200. The gearshift actuators are controlled via respectively a first shifter having a first electronic shift sensor and a second shifter having a second electronic shift sensor. The first and second shifters are mounted to handlebar 1005 of the bicycle, to be manually operable by a user of the bicycle while bicycling.

Here, the second transmission 200 is part of the hub assembly 1024, here an internally geared hub assembly. The hub assembly 1024 may include a planetary gear set and one or more clutches, e.g. for providing two or three different transmission ratios. The hub assembly may include two planetary gear sets and one or more clutches, e.g. for providing two, three, four, six or nine different transmission ratios.

In addition, or alternatively, to the first and second gearshift actuators and the first and second shift sensors, the bicycle may be provided with various other electronic actuators and electronic sensors, e.g. including but not limited to an electronic brake sensor, an electronic power sensor, an electronic cadence sensor, an electronic speed sensor, and an electronic position sensor, an electronic brake actuator, and an electronic seat-post height actuator, an electronic suspension actuator.

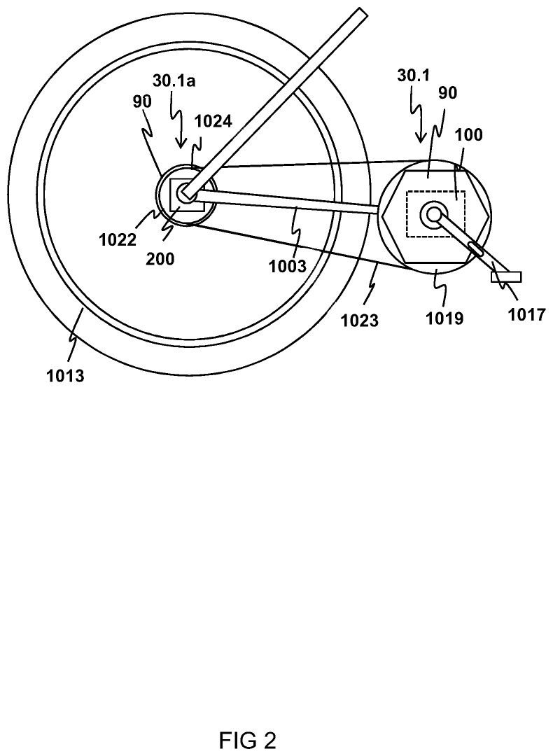

FIG. 2 shows a close-up of a rear of a bicycle 1000, provided with an energy harvesting unit for harvesting energy and supplying the harvested energy to one or more of the various sensors and actuators of the bicycle. In the example of FIG. 2, the bicycle 1000 is provided with a first energy converter module 30.1 of the energy harvesting unit, here comprising a photovoltaic cell 90. The photovoltaic cell 90 is in this case provided on the front chainwheel 1019, particularly on an outward facing side of the front chainwheel 1019. The photovoltaic cell 90 is configured to convert solar energy into electric energy to be supplied to one or more of the sensors and actuators. The first converter module 30.1 is local to the first transmission 100 and the first gearshift actuator. Hence, the first converter module may be so connected to power the first gearshift actuator. The first converter module 30.1 may also be so connected to power multiple electronic actuators and sensors. In the example of FIG. 2, the bicycle 1000 is provided with a further energy converter module 30.1a of the energy harvesting unit, here also comprising a photovoltaic cell 90. This photovoltaic cell 90 is in this case provided on the hub 1022, particularly on an outward facing surface of the hub 1022. The photovoltaic cell 90 is configured to convert solar energy into electric energy to be supplied to one or more of the sensors and actuators. The further converter module 30.1a is local to the second transmission 200 and the second gearshift actuator. Hence, the further converter module may be so connected to power the second gearshift actuator. The further converter module 30.1a may also be so connected to power multiple electronic actuators and sensors. The hub assembly 1024 may include a battery for storing electric energy generated by the further converter module 30.1a.

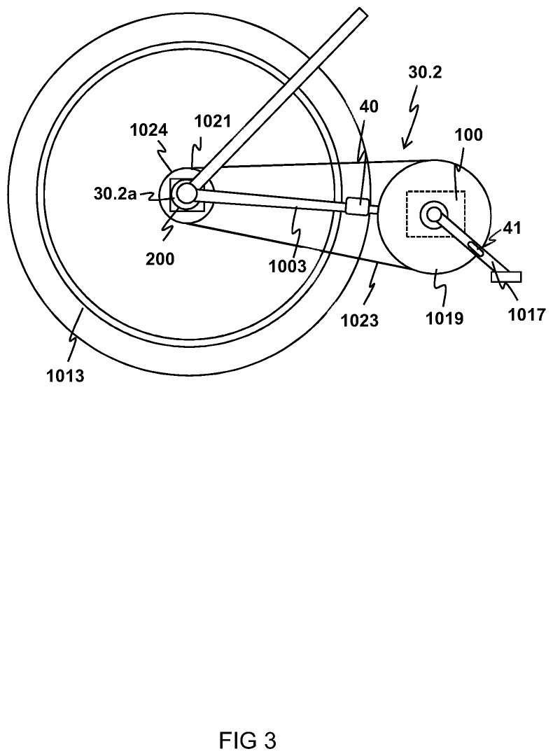

FIG. 3 shows a close-up of a rear of a bicycle 1000 provided with an energy harvesting unit for harvesting energy and supplying the harvested energy to one or more of the various sensors and actuators of the bicycle. Here, the bicycle 1000 is provided with a second converter module 30.2, here comprising an electric generator arranged for converting motive energy of a bicycle component into electric energy. The electric generator comprises a stator 40 which is coupled to the frame 1002, particularly to a chain stay 1003 of the frame. The electric generator 30.2 also comprises a rotor which is in this example formed by the crank 1017. The rotor includes a magnetic element 41. The stator 40 and magnetic element 41 are mounted such that the magnetic element 41 passes the stator 40 in use when pedaling the crank 1017. Hence each rotation of the crank 1017, the magnetic 41 passes the stator 40 at least once. The stator 40 here includes an inductor element, configured for inducing an electric current upon passing of the magnetic element 41. In the example of FIG. 3, the bicycle 1000 is provided with a further energy converter module 30.2a of the energy harvesting unit. The further energy converter module 30.2a is in this case provided inside or on the hub assembly 1024. The further converter module 30.2a here comprises an electric generator arranged for converting rotation of the hub 1022 and/or rotation of a part of the second transmission into electric energy. The further converter module 30.2a is local to the second transmission 200 and the second gearshift actuator. Hence, the further converter module may be so connected to power the second gearshift actuator. The further converter module 30.2a may also be so connected to power multiple electronic actuators and sensors. The hub assembly 1024 may include a battery for storing electric energy generated by the further converter module 30.2a.

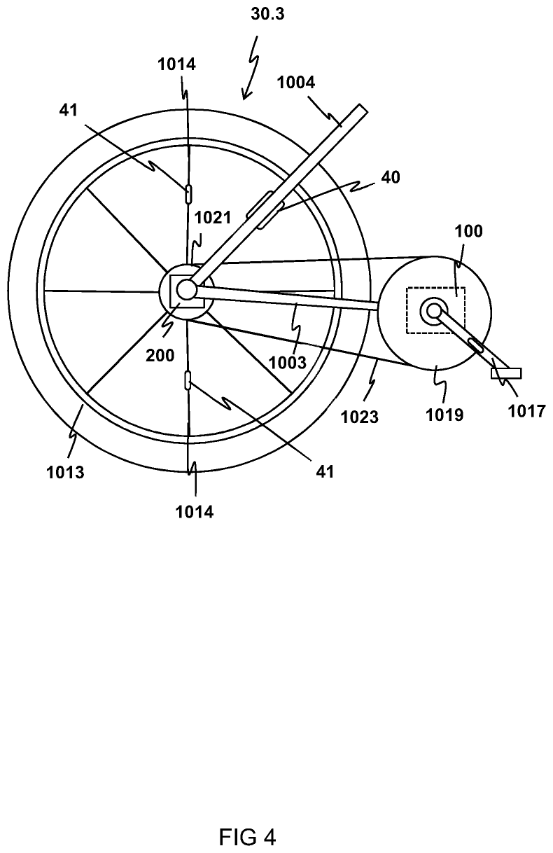

FIG. 4 shows a close-up of a rear of a bicycle 1000 provided with an energy harvesting unit for harvesting energy and supplying the harvested energy to one or more of the various sensors and actuators of the bicycle. Here, the bicycle 1000 is provided with a third converter module 30.3. The third converter module 30.3, here comprising an electric generator, similar to the electric generator as described in view of FIG. 3, comprises a rotor which is formed in this example by the rear wheel 1013, more particular by spokes 1014 of the rear wheel 1013. The magnetic element 41, in this case two magnetic elements 41, is mounted to spokes 1014 of the rear wheel 1013, and corotates therewith about the wheel rotations axis. The stator 40 is mounted, in this example, to the seat stay 1004 of the frame 1002. The stator 40 and magnetic elements 41 are so mounted such the magnetic elements 41 pass the stator 40 in use when rotating the rear wheel 1013.

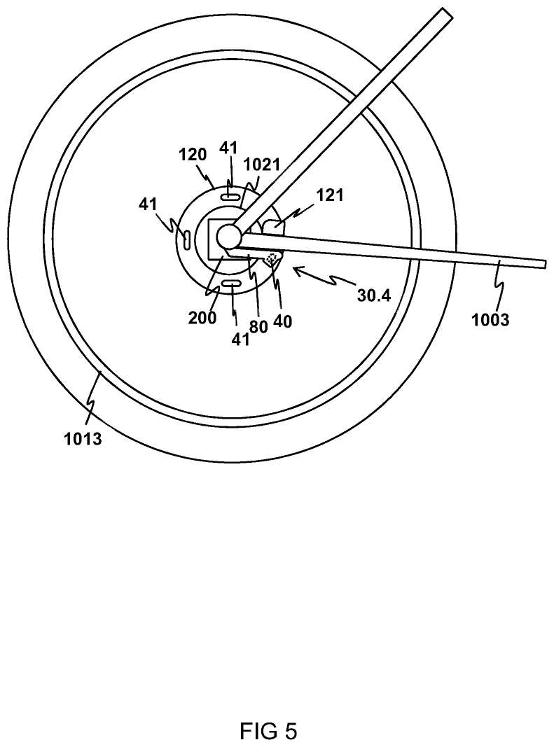

FIG. 5 shows a close-up of a rear of a bicycle 1000 provided with an energy harvesting unit for harvesting energy and supplying the harvested energy to one or more of the various sensors and actuators of the bicycle. Here, the bicycle 1000 is provided with a fourth converter module 30.4. The fourth converter module 30.4, here comprising an electric generator, similar to the electric generators as described in view of FIGS. 3 and 4, comprises a rotor which is formed by the rear wheel 1013, more particular by a brake disc 120 mounted to the rear wheel 1013. The brake disc 120 can be engaged by a brake caliper 121, to brake a rotation of the rear wheel 1013. The brake disc 120 is provided with the magnetic element 41, in this example four magnetic elements 41, provided at a constant radius from the rear wheel rotation axis. The stator 40 is in this example mounted to a torque support element 80, but could alternatively be e.g. mounted to the frame such as to a seat stay or chain stay. The torque support element 80 is configured for supporting a torque of a hollow shaft of the second transmission 200 onto the frame 1002 of the bicycle 1000, particularly to the chain stay 1003. The fourth converter module 30.4 is so arranged that each magnetic element 41 passes the stator 40 every full rotation of the rear wheel 1013, for generating electric power.

It will be appreciated that a bicycle 1000 may be provided with any one or more of the converter modules 30.1-30.4.

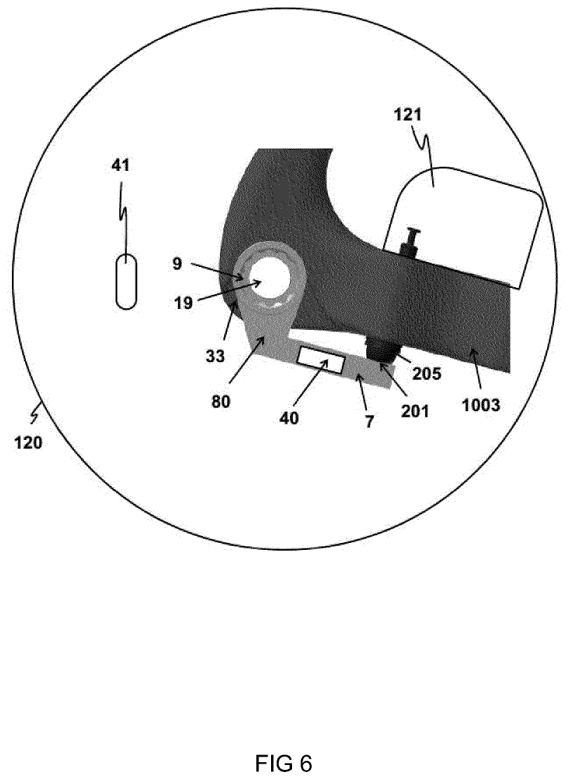

FIG. 6 shows a schematic example of an energy converter module, as explained in view of FIG. 5, wherein the stator is mounted to, or integrated with, a torque support element 80. In this example, the torque support element 80 is received in a dropout recess 33 of the frame 1002. The torque support element has a cam hole 9 for receiving a hollow shaft in a rotationally interlocking manner. Here, the cam hole 9 has spline teeth for interlocking with complementary spline teeth on a radially outer circumferential surface of the of the hollow shaft. The torque support element 80 also comprises a through hole 19 that extends through the torque support element 80. The through hole 19 is coaxial with the cam hole 9 for allowing a thru-axle to extend there through.

The torque support element 80 in this example has a boss suitable for fitting inside the drop out recess 33. The boss 14 extends around the through hole 9. Here the boss 14 is substantially circular, for aligning the through hole 9 with a hole in the dropout, and to allow for a rotation of the torque support element 80 within the dropout recess 33. In a variant of the torque support element 80 it is possible that the boss 14 is key shaped which matches a key-hole shape in the drop-out, such that torque can be fully or partially be supported within the key-hole in one or two rotation directions.

The torque support element 80 comprises a base 7. The base 7 extends outward from a remainder of the torque support element 80, in a direction transverse to an axial direction of the through hole 9. The base 7 is arranged to engage the bicycle frame 1002. In use, the base 7 forms a lever arm to support torque that is exerted on the hollow shaft onto the frame 1002. Here, the base 7 engages the chain-stay 1003 of the bicycle frame 1002. The base 7 comprises an abutment surface 201 arranged for abutting the frame 31. The base can be touching directly on the frame 1002 and/or the abutment surface 201 can particularly engage a brake caliper mount connector 205, such as in this example, here via a bolt. The base 7, in this example, is not affixed to the frame 1002. It will be clear that nevertheless the base 7 can transfer torque onto the frame 1002 at least in one rotational direction. It will be appreciated that the base 7 can be affixed, for example bolted, to the frame 1002, e.g. by the bolt of the brake caliper mount connector. In the example shown in FIG. 6, the torque support element 80 comprises a cavity for accommodating the stator 40.

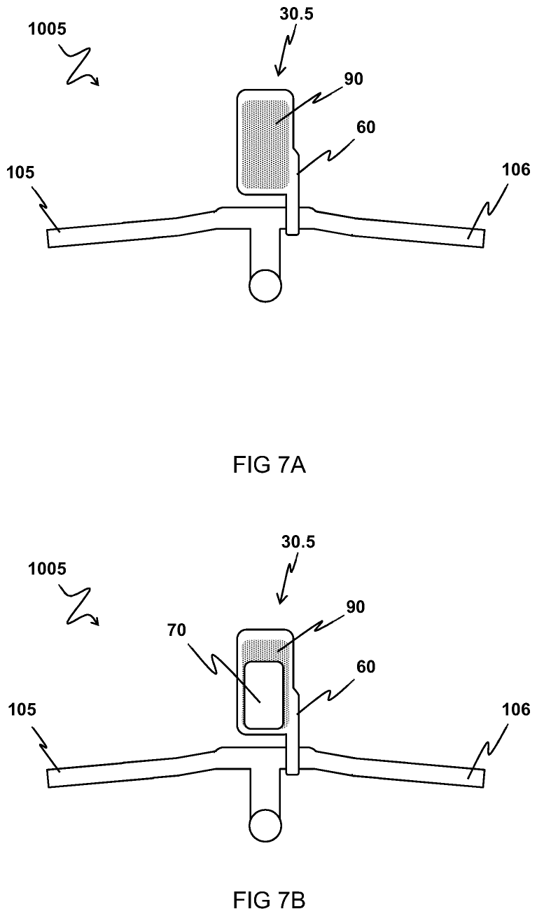

FIGS. 7A and 7B show a schematic top view of a handlebar 1005 of a bicycle 1000, here flat bar handlebar, but a city handlebar or drop handlebar is also possible. The handlebar has a left hand grip portion 105 for being grasped by a left hand of the user, and a right hand grip portion 106 for being grasped by a right hand of the user, while bicycling. The handlebar 1005 includes a docking member 60, mounted to the handlebar 1005, for releasably docking a bicycle computer 70. FIG. 7A shows the docking member 60 without the bicycle computer 70, and FIG. 7B shows the docking member 60 with the bicycle computer 70 docked onto the docking member 60. The docking member 60 comprises a top surface, wherein a fifth energy converter module 30.5, here comprising a photovoltaic cell 90, is provided on the docking member 60 top surface. The bicycle computer 70 does not completely cover the docking member 60. The top surface of the docking member 60, here, comprises a central part for receiving thereon the bicycle computer 70 in a docking position, and a peripheral part configured to remain uncovered when the bicycle computer 70 is received in the docking position. The photovoltaic cell 90 extends at least to the peripheral part, such that the photovoltaic cell 90 is exposed to receive solar radiation also when the bicycle computer 70 is docked. In case no bicycle computer 70 is docked, the area of the photovoltaic cell 90 is maximized. It is also possible that the photovoltaic cell 90 only extends in the peripheral part, so as to never be obstructed by the bicycle computer 70. It will be appreciated that the bicycle computer may a dedicated bicycle computer device, or an all-purpose computer device such as a smartphone or tablet.

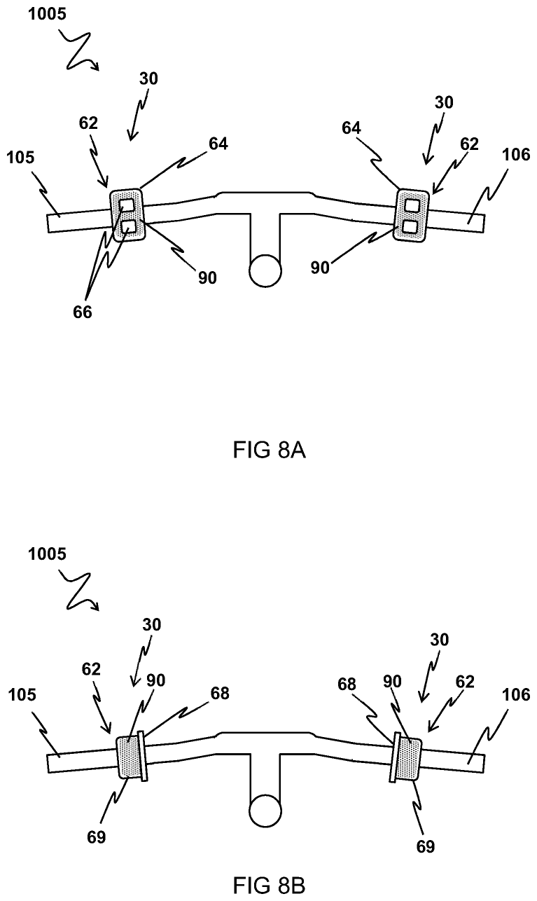

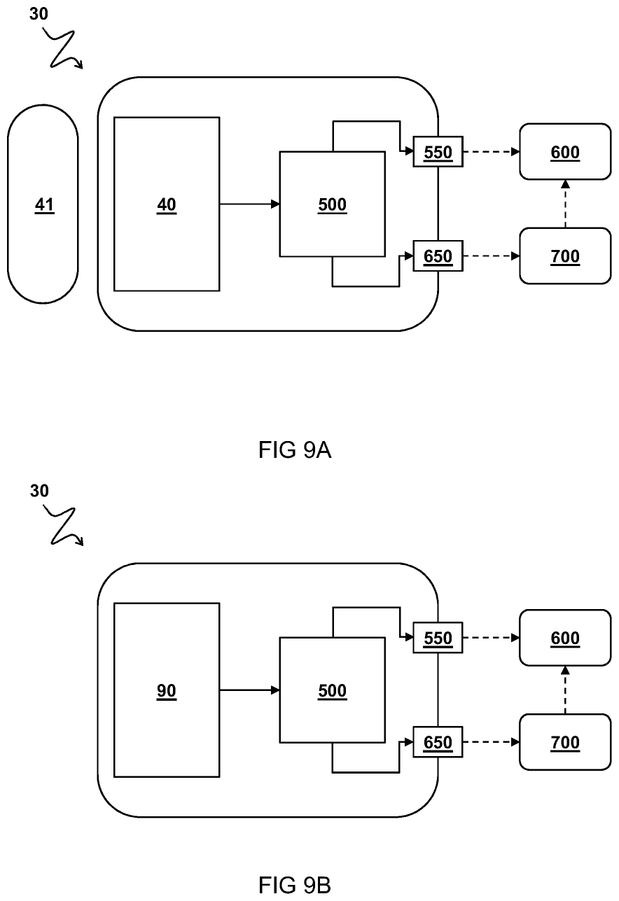

FIGS. 8A and 8B show a schematic top view of a handlebar 1005 of a bicycle 1000, here flat bar handlebar, but a city handlebar or drop handlebar is also possible. The handlebar has a left hand grip portion 105 for being grasped by a left hand of the user, and a right hand grip portion 106 for being grasped by a right hand of the user, while bicycling. The handlebar 1005 includes one or more manually operable shifters 62. Here a first manually operable shifter 62 is mounted near the left hand grip portion 105 and a second manually operable shifter is mounted near the right hand grip portion 106. In the example of FIG. 8A, the manually operable shifters 62 each include a body 64 two buttons 66, although another number of buttons, or levers instead of, or in addition to buttons, is conceived. The manually operable shifters 62 each include an electronic shifter sensor configured to sense a manual user actuation of the buttons 66. In this example a photovoltaic cell 90 is provided on an outer face of the body 64. In the example of FIG. 8B, the manually operable shifters 62 each include a base 68 fixed to the handlebar 1005 and an operating element 69 coupled to the base 68 so as to be rotatable with respect to the base about a rotation axis parallel to a local center line of the handlebar 1005. In this example, the operating element 69 is substantially ring-shaped, such as substantially cylindrical, optionally tapered and/or beveled, optionally including one or more protrusions and/or depressions. The substantially ring-shaped operating element 69 is mounted to be rotatable about the handlebar 1005. The manually operable shifters 62 each include an electronic shifter sensor configured to sense a manual user actuation of the operating element 69. In this example a photovoltaic cell 90 is provided on an outer face of the operating element 69. The photovoltaic cell 90 in the examples of FIGS. 8A and 8B is for providing electric power (only) to the electronic shift sensor, and optionally a transmitter and other associated electronics, of the manually operable shifter 62 to which the photovoltaic cell is mounted. Each manually operable shifters 62 may include a battery for storing electric energy generated by its photovoltaic cell.

FIGS. 9A and 9B show a schematic example of an energy converter module 30. The converter module 30 of FIG. 9A comprises a stator 40, with an inductor, and an associated magnetic element 41 to be mounted to a rotor. The converter module 30 of FIG. 9B comprises a photovoltaic cell 90. The converter module 30 may further comprises auxiliary circuitry for, e.g., rectifying and boosting an electric signal from the stator 40 or the photovoltaic cell 90. The auxiliary circuitry may be configured for directing the generated electric power to one or more electronic sensors and/or actuators 600, and/or to a power storage device 700, e.g. a battery. The converter module may for example comprises a first connector 550 for connecting the converter module 30 to one or more electronic sensors and/or actuators 600. The converter module may also be integrated in a housing of an electronic sensor and/or actuator. The converter module may also, for example, comprise a second connector 650 for connecting the converter module 30 to the power storage 700. The one or more sensors and actuators 600 may also be directly connected to the power storage 700, to draw power directly from the power storage 700.

Each energy converter module 30 of the energy harvesting unit may have its own module battery for storing energy. Each converter module 30 may be so connected that it charges only its own module battery. Multiple energy converter modules may also be connected to a common battery. For example, in addition to its module battery, a converter module 30 may additionally be connected to a common battery, e.g. to selectively charge the module battery or the common battery. A switch may be provided to switch between charging the module battery and the common battery. Some or all of the converter modules may also be so connected to charge only the common battery. Some or all of the converter modules may also be so connected to charge only the common battery.

Each energy converter module 30 of the energy harvesting unit may be connected to a single electronic sensor or actuator. Hence, each converter module 30 may be so connected to power only one sensor or actuator. Some energy converter module 30 may be so connected to power a pair of electronic sensors and actuators. For example, a single converter module may power a shifter sensor as well as its associated shifter actuator. For example, the energy harvesting system may include a first converter module so connected to power a first electronic shifter sensor as well as a first electronic shifter actuator, wherein the first electronic shifter sensor and the first electronic shifter actuator are associated, e.g. paired, with one another. The energy harvesting system may, for example, also include a second converter module so connected to power a second electronic shifter sensor as well as a second electronic shifter actuator, wherein the second electronic shifter sensor and the second electronic shifter actuator are associated, e.g. paired, with one another.

A single converter module may e.g. power a left hand shifter sensor as well as a right hand shifter sensor. A single converter module may e.g. power an electric rear derailleur actuator as well as an electric front derailleur actuator. A single converter module may e.g. power an electric rear derailleur actuator as well as a rear wheel hub transmission actuator. A single converter module may e.g. power a first and a second rear wheel hub transmission actuator. A single converter module may e.g. power a first and a second crank transmission actuator. A single converter module may e.g. power a rear wheel hub transmission actuator as well as crank transmission actuator. A single converter module may e.g. power a crank transmission actuator as well as a torque sensor.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

For the purpose of clarity and a concise description features are described herein as part of the same or separate embodiments, however, it will be appreciated that the scope of the invention may include embodiments having combinations of all or some of the features described.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A system for a bicycle, comprising one or more electronic sensors, and/or one or more electronic actuators, and an energy harvesting unit configured for harvesting energy and supplying the harvested energy to the one or more electronic sensors and/or the one or more electronic actuators.

2. The system of claim 1, wherein the energy harvesting unit is arranged for converting kinetic energy of a bicycle component and/or radiation energy into electric energy, and supplying the electric energy to the one or more electronic sensors and/or the one or more electronic actuators.

3. The system of claim 1, wherein the energy harvesting unit comprises a plurality of energy converter modules for converting kinetic energy of a bicycle component and/or radiation energy into electric energy.

4. The system of claim 3, wherein each energy converter module is connected to a different one of the one or more electronic sensors and/or one or more electronic actuators.

5. (canceled)

6. The system of claim 3, wherein each energy converter module is local to the respective electronic sensor or actuator connected thereto.

7. The system of claim 3, wherein each energy converter module includes a module battery.

8. (canceled)

9. The system of claim 3, wherein at least two energy converter modules of the plurality of converter modules share a common battery.

10. (canceled)

11. (canceled)

12. The system of claim 1, wherein at least one energy converter module of a plurality of energy converter modules comprises an electric generator for converting rotary energy of a bicycle component to electric energy, the electric generator having a rotor for being mounted to a rotary component of the bicycle and a stator for being mounted to a non-rotary component of the bicycle.

13. (canceled)

14. The system of claim 12, wherein the rotor is configured to be mounted to a brake disc of the bicycle.

15. The system of claim 14, wherein the stator is configured to be mounted to, or integrated with, a torque support element.

16. (canceled)

17. The system of claim 1, wherein at least one energy converter module of a plurality of energy converter modules comprises a photovoltaic cell for converting solar energy to electric energy.

18. The system of claim 17, wherein the photovoltaic cell is arranged on a chainring or on a wheel hub assembly.

19. The system of claim 1, wherein the one or more electronic sensors include one or more of an electronic shifter sensor, an electronic brake sensor, an electronic power sensor, an electronic cadence sensor, an electronic speed sensor, and an electronic position sensor, and/or wherein the one or more electronic actuators include one or more of an electronic shift actuator, an electronic brake actuator, and an electronic seat-post height actuator.

20. The system of claim 1, comprising an electronic shift sensor configured for transmitting an electronic shift signal upon sensing a user actuation thereof; and an electronic shift actuator configured for receiving the electronic shift signal and actuating a gearshift upon receipt of the electronic shift signal wherein the photovoltaic cell is arranged on a manually operable shifter comprising the electronic shift sensor.

21. (canceled)

22. The system of claim 1, comprising an electronic brake sensor configured for transmitting an electronic brake signal upon sensing a user actuation thereof; and an electronic brake actuator configured for receiving the electronic brake signal and actuating a brake action upon receipt of the electronic brake signal.

23. A bicycle comprising the system of claim 1.

24. The bicycle of claim 23, comprising a transmission operable according to a plurality of transmission ratios, the transmission having an input connected to a crank and an output connected to a driven wheel, wherein the energy harvesting unit is arranged for converting kinetic energy of a component of the transmission to electric energy.

25. The bicycle of claim 24, wherein the transmission comprises a planetary gearset including a ring gear, a planet carrier carrying one or more planet gears, and a sun gear, wherein the energy harvesting unit is arranged for converting kinetic energy of at least one of the ring gear, the planet carrier, the one or more planet gears, and the sun gear to electric energy.

26. The bicycle of claim 24, wherein the transmission comprises a crank spindle which is rotatably drivable relative to a bottom bracket by a crank, wherein the energy harvesting unit is arranged for converting kinetic energy of at least one of a front chainwheel, the crank, and the crank spindle to electric energy.

27. The bicycle of claim 26, wherein the energy harvesting unit comprises a crank converter module, for converting motive power of at least one of a front chainwheel, the crank, and the crank spindle into electric power, wherein the crank converter module is so connected to power one or more local electronic sensors such as a torque sensor and/or a speed sensor.

28. The bicycle of claim 23, comprising an endless drive member, and a tensioner wheel for tensioning the endless drive member, wherein the energy harvesting unit is configured for converting kinetic energy of the tensioner wheel to electric energy.

29. The bicycle of claim 23, wherein the energy harvesting unit comprises a photovoltaic cell for converting solar energy into electric energy, wherein the photovoltaic cell is provided on one or more of:
a face of a front chainwheel, particularly on an, in use, outward facing face of the front chainwheel;
an outer face of a wheel hub assembly:
a docking member for releasably docking a bicycle computer, the docking member being arranged for being mounted to, or integrated with, a handlebar;
a portion of a frame, particularly on a, in use, top face of the frame;
a fender, particularly on a, in use, top face of the fender;
a handlebar; or
an outer face of a manually operable shifter, e.g. on a substantially ring-shaped operating element of the manually operable shifter.

30.-38. (canceled)
